(19) United States
(12) Patent Application Publication
(10) Pub. No.: US 2013/0196619 A1
(43) Pub. Date: Aug. 1, 2013

(54) SYSTEM AND METHOD FOR PREPAID MULTIPLE SERVICES CARDS

(71) Applicants: JAMES JU, Hillsdale, NJ (US); YOUNGHO CHUN, Fort Lee, NJ (US); JUNHYUK SEO, Fort Lee, NJ (US)

(72) Inventors: JAMES JU, Hillsdale, NJ (US); YOUNGHO CHUN, Fort Lee, NJ (US); JUNHYUK SEO, Fort Lee, NJ (US)

(21) Appl. No.: 13/565,866

(22) Filed: Aug. 3, 2012

Related U.S. Application Data
(60) Provisional application No. 61/515,461, filed on Aug. 5, 2011.

(51) Int. Cl. H04W 4/24

(52) U.S. Cl. CPC H04W 4/24
USPC 455/406

(57) ABSTRACT

The present invention relates to a method and system for allowing a user to access multiple services by providing an access code having a monetary balance associated therewith. A first monetary amount, which is not greater than the monetary balance of the access code, is assigned to a first account balance associated with the access code and usable only in conjunction with a first service. A second monetary amount, which is not greater than the monetary balance of the access code, is assigned to a second account balance associated with the access code and usable only in conjunction with a second service, which is different from the first service. In this manner, the access code can be used by the user to redeem the monetary balance in conjunction with both the first service and the second service.

### CROSS-REFERENCE TO RELATED APPLICATION

This application claims the benefit of U.S. Provisional Application No. 61/515,461 filed Aug. 5, 2011, the disclosure of which is incorporated herein by reference in its entirety.

### FIELD OF THE INVENTION

The present invention relates to a system and method for a prepaid services card and, more particularly, to a system and method for a prepaid multiple services card using a single access code or personal identification number (PIN).

### BACKGROUND OF THE INVENTION

Prepaid services cards are currently available for accessing or receiving a variety of services. Each service requires an individual access code or personal identification number (PIN) for accessing the service. Examples of these cards include prepaid telephone calling cards and prepaid airtime recharge or top-up cards for wireless or cellular telephone numbers (i.e., accounts).

### SUMMARY OF THE INVENTION

In accordance with an embodiment of the present invention, a method and system are provided for allowing a user to access multiple services. More particularly, an access code having a monetary balance associated therewith is provided to the user. A first monetary amount, which is not greater than the monetary balance of the access code, is assigned to a first account balance associated with the access code and usable only in conjunction with a first service. A second monetary amount, which is not greater than the monetary balance of the access code, is assigned to a second account balance associated with the access code and usable only in conjunction with a second service, which is different from the first service. In this manner, the access code can be used by the user to redeem the monetary balance in conjunction with both the first service and the second service.

In accordance with another embodiment of the present invention, a system and method are provided for accessing or providing multiple types of services (e.g., financial and telecommunication services) using a single PIN (i.e., access code). In order to use the single PIN, the system employs a method for tracking an account value associated with each of the services associated with the PIN. More particularly, the system enters the account value associated with each of the services in a main database, as well as a local database associated with each of the services. As the card is used (i.e., one or more of the services associated with same is accessed or used), the account values in the main database and/or the local databases corresponding to the services are adjusted accordingly. The validation process includes verifying the PIN in the main database.

### BRIEF DESCRIPTION OF THE DRAWINGS

For a more complete understanding of the present invention, reference is made to the following detailed description of the exemplary embodiments considered in conjunction with the accompanying drawings, in which:

FIG. 1 is a schematic illustration of a prepaid multiple services card system constructed in accordance with a first embodiment of the present invention;

FIG. 2A is a diagram of a PIN value master chart associated with the system of FIG. 1;

FIG. 2B is a diagram of a calling card account value chart associated with the system of FIG. 1;

FIG. 2C is a diagram of a wireless account value chart associated with the system of FIG. 1;

FIG. 2D is a diagram of a money remittance account value chart associated with the system of FIG. 1;

FIG. 2E is a diagram of a bill pay account value chart associated with the system of FIG. 1;

FIG. 3 is an illustration of a prepaid multiple services card used in conjunction with the system of FIG. 1, the card being usable to receive a prepaid calling card service, a wireless telephone service, a money remittance service and a bill pay service;

FIG. 4 is a flow chart illustrating an overall process associated with the card shown in FIG. 3;

FIG. 5 is a diagram depicting the PIN value master chart of FIG. 2A after the completion of an activation process associated with the card shown in FIG. 3;

FIG. 6 is a flow diagram depicting a calling card redemption process associated with the system of FIG. 1;

FIG. 7A is a diagram depicting the PIN value master chart shown in FIG. 2A after the completion of the calling card redemption process shown in FIG. 6;

FIG. 7B is a diagram depicting the calling card account value chart shown in FIG. 2B after the completion of the calling card redemption process shown in FIG. 6;

FIG. 8 is a flow diagram depicting a wireless telephone redemption process associated with the system of FIG. 1;

FIG. 9A is a diagram depicting the PIN value master chart shown in FIG. 2A after the completion of the wireless telephone redemption process shown in FIG. 8;

FIG. 9B is a diagram depicting the wireless account value chart shown in FIG. 2C after the completion of the wireless telephone redemption process shown in 8;

FIG. 10 is a flow diagram depicting a money remittance redemption process associated with the system of FIG. 1;

FIG. 11A is a diagram depicting the PIN value master chart shown in FIG. 2A after the completion of the money remittance redemption process shown in FIG. 10;

FIG. 11B is a diagram depicting the money remittance account value chart shown in FIG. 2D after the completion of the money remittance redemption process shown in FIG. 10;

FIG. 12 is a flow diagram depicting a bill pay redemption process is associated with the system of FIG. 1;

FIG. 13A is a diagram depicting the PIN value master chart shown in FIG. 2A after the completion of the bill pay redemption process shown in FIG. 12;

FIG. 13B is a diagram depicting the bill pay account value chart shown in FIG. 2E after the completion of the bill pay redemption process shown in FIG. 12;

FIG. 14 is a schematic illustration of a prepaid multiple services card system constructed in accordance with a second embodiment of the present invention;

FIG. 15 is an illustration of a prepaid multiple services card used in conjunction with the system shown in FIG. 14, the card being usable to receive or access a telephone calling card service and a wireless telephone service;

FIG. 16A is an illustration of a PIN value master chart used in conjunction with the system shown in FIG. 14;

FIG. 16B is an illustration of a calling card account value chart used in conjunction with the system shown in FIG. 14;

FIG. 16C is an illustration of a wireless account value chart used in conjunction with the system shown in FIG. 14;

FIG. 17A is an illustration of the calling card account value chart shown in FIG. 16B after the completion of an activation process associated with the card shown in FIG. 14; and

FIG. 17B is an illustration of the wireless account value chart shown in FIG. 16C after the completion of the activation process associated with the card shown in FIG. 14.

### DETAILED DESCRIPTION OF THE INVENTION

The present invention can be used in conjunction with many different services provided to consumers or end users. However, the present invention is particularly suitable for use in connection with the following services: telephone calling card services allowing users to make local, domestic or international telephone calls with the use of prepaid telephone calling cards (hereinafter “calling card services”); airtime recharge or top-up services allowing users to recharge or top up prepaid wireless telephone accounts in the United States (i.e., domestic) or in foreign countries (i.e., international) (hereinafter “wireless services”); money remittance services allowing users to remit or wire an amount of money to designated recipients in the United States or foreign countries through domestic or international money remittance service companies, such as the company known as “WESTERN UNION” (hereinafter “money remittance services”); and bill pay services allowing users to pay bills, such as gas, electric or telephone bills, etc., issued in the United States or in foreign countries, through domestic or international bill payment service companies, such as the company known as “WESTERN UNION” (hereinafter “bill pay services”). In such circumstances, the present invention will be discussed below in conjunction with calling card, wireless, money remittance and/or bill pay services. It should be noted that the following discussion is intended for illustration purposes only and is not meant to limit the scope of the present invention, which has applicability to numerous additional services.

### First Embodiment

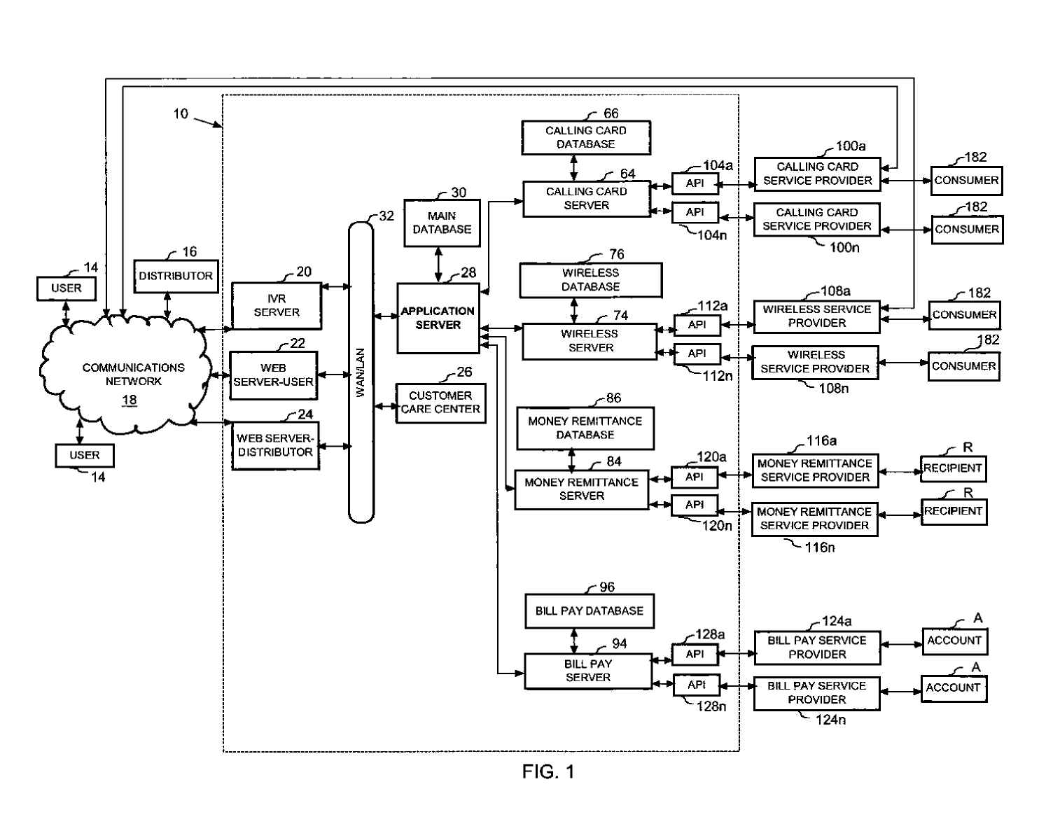

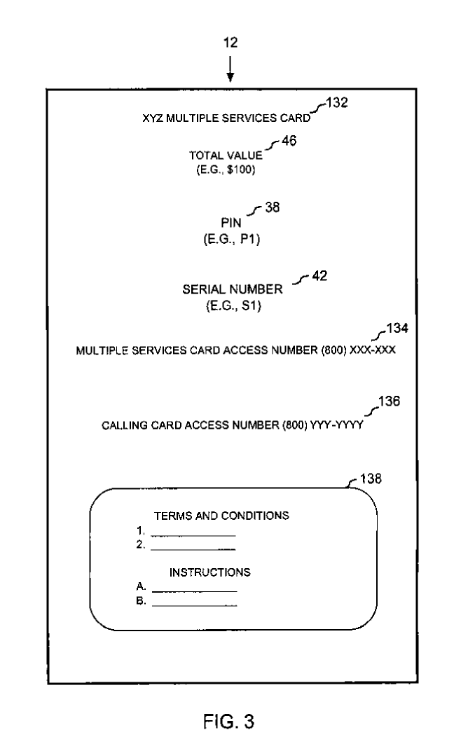

FIG. 1 illustrates a system 10 constructed in accordance with a first embodiment of the present invention. The system 10 is used in conjunction with prepaid multiple services cards 12 (see FIG. 3), which are supplied or sold to users 14 (e.g., consumers) directly or indirectly via distributors 16 (e.g., retailers, vendors, etc.). The system 10 allows each user 14 to access a plurality of services with a single PIN associated with each card 12. The services that can be received or accessed with the use of the cards 12 include calling card, wireless, money remittance and bill pay services.

Referring to FIG. 1, the system 10 is connected to a communications network 18 that includes wireline or wireless facilities, switched or packet (TCP/IP) connections and other conventional protocols/facilities. Each user 14 can interact with the system 10 using an interactive voice response unit 20 (hereinafter “IVR unit”) through the interconnection provided by the communications network 18. As is conventional in the telecommunication field, telecommunication devices such as private telephones, public pay phones, mobile or cellular phones, etc. are connected to the communications network 18, such that the users 14 can access the IVR unit 20 from such telecommunication devices. The IVR unit 20 is programmed to perform a number of automated customer service functions which are discussed in greater detail hereinafter.

The users 14 and the distributors 16 can also interact with the system 10 by the use of a web server—user 22 and a web server-distributor 24, respectively, through interconnection provided by the communications network 18. As is conventional in the data communications field, data communications devices such as point of service terminals (POST), desk top computers, smart phones, laptop computers, etc. are connected to the communications network 18, so that the users 14 and the distributors 16 can access the web server—user 22 and the web server-distributor 24, respectively, from such data communications devices. For instance, the web server—user 22 and the web server-distributor 24 can be programmed to perform a number of automated customer service functions to be discussed hereinafter. The web server—user 22 is programmed to perform automated customer service functions similar to those performed by the IVR unit 20. The system 10 also includes a customer care unit or center 26 which provides assistance to the users 14 and/or the distributors 16 via service representative personnel when the system 10 is unable to provide automated customer service functions.

The system 10 also includes an application server 28 connected directly or indirectly to a main database 30. A function of the application server 28 includes the overall automated operation of the system 10. The application server 28 includes programs that are resident on computer readable media and are processed by a microcomputer of the application server 28. One or more embodiments of the present invention may be implemented with one or more computer readable media, wherein each medium may be configured to include thereon data or computer executable instructions. The computer executable instructions include data structures, objects, programs, routines, or other program modules that may be accessed by a processing system, such as one associated with a general-purpose computer or processor capable of performing various different functions or one associated with a special-purpose computer capable of performing a limited number of functions. Computer executable instructions cause the processing system to perform a particular function or group of functions and are examples of program codes for implementing steps for methods discussed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including general purpose computers, special purpose computers, application-specific integrated circuit (ASIC), and digital/analog circuits with discrete components, for example. The IVR unit 20, the web server-user 22 and the web server-distributor 24 are connected to the application server 28 by a local or wide area network 32 (e.g., a TCP/IP based WAN/LAN), or other suitable network such as a virtual private network (VPN).

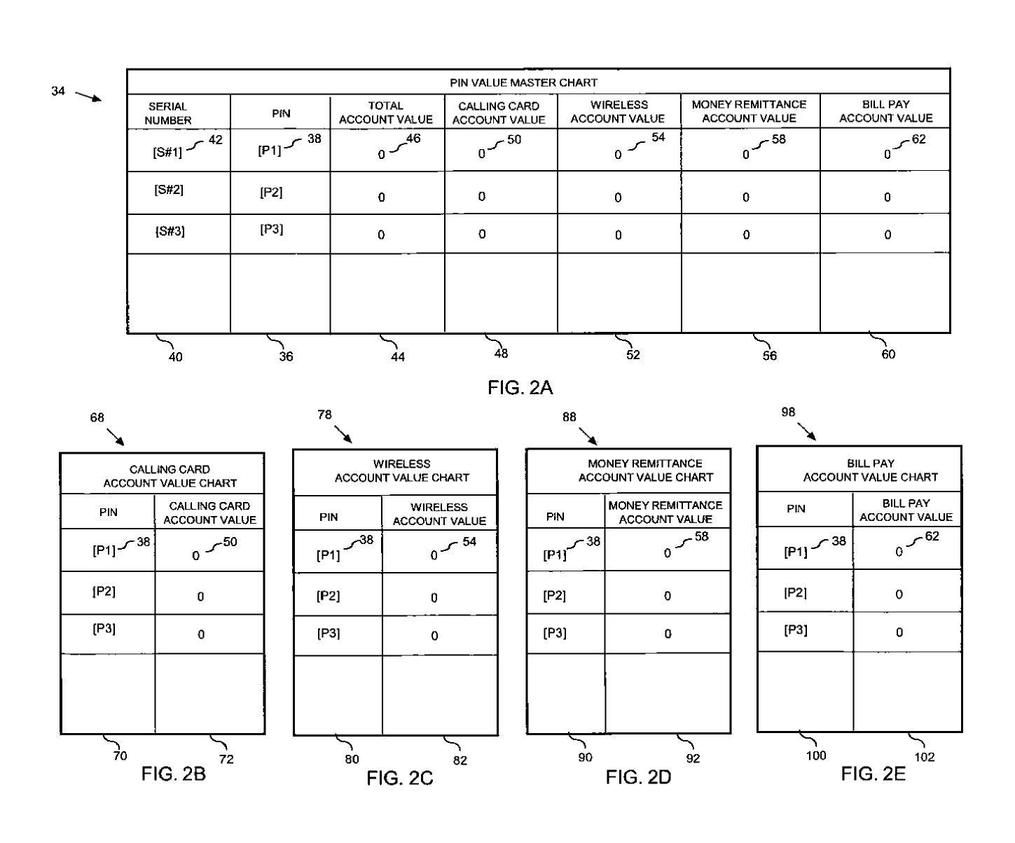

Referring FIG. 2A, the main database 30 is adapted to maintain data associated with the cards 12 in a PIN value master chart 34. The PIN value master chart 34 includes a PIN column 36 for containing or recording therein a list of PINs (see also FIG. 3). The PIN value master chart 34 includes a serial number column 40 for containing or recording therein a list of serial numbers 42 (see also FIG. 3), each of which is associated with a corresponding one of the PINs 38. The PIN value master chart 34 also includes a total account value column 44 for containing or recording herein a list of total account values 46 (see also FIG. 3), each of which is associated with a corresponding one of the PINs 38. The PIN value master chart 34 also includes (i) a calling card account value column 48 for containing or recording therein a list of calling card service account values 50, (ii) a wireless account value column 52 for containing or recording therein a list of wireless service account values 54, (iii) a money remittance account value column 56 for containing or recording therein a list of money remittance service account values 58, and (iv) a bill pay account value column 60 for containing or recording therein a list of bill pay service account values 62. The functions and use of the PIN value master chart 34 are discussed in greater detail hereinbelow.

Referring back to FIG. 1, the application server 28 is connected to a calling card service server 64, which is coupled to a calling card service database 66. With reference to FIG. 2B, a calling card service account value chart 68 is created in the calling card service database 66. More particularly, the calling card service account value chart 68 includes a PIN column TO for recording therein one or more of the PINs 38 (e.g., P1, P2, P3), as well as a calling card account value column 72 for recording therein the calling card service account values 50 associated with the PINs 38.

The application server 28 is also connected to a wireless service server 74, which is coupled to a wireless service database 76 (see FIG. 1). Referring to FIG. 2C, a wireless service account value chart 78 is created in the wireless service database 76. More particularly, the wireless service account value chart 78 includes a PIN column 80 for recording therein one or more of the PINs 38, as well as a wireless service account value column 82 for recording therein the wireless service account values 54 associated with the PINs 38.

A money remittance service server 84 is connected to the application server 28, as well as to a money remittance service database 86 (see FIG. 1). Referring to FIG. 2D, a money remittance service account value chart 88 is created in the money remittance service server 84 for purposes to be discussed hereinafter. The money remittance service account value chart 88 includes a PIN column 90 for recording therein one or more of the PINs 38, and a money remittance service account value column 92 for recording therein the money remittance service account values 58 associated with the PINs 38.

The application server 28 is also connected to a bill pay service server 94, which is coupled to a bill pay service database 96 (see FIG. 1). Referring to FIG. 2E, a bill pay service account value chart 98 is created in the bill pay service database 96. More particularly, the bill pay service account value chart 98 includes a PIN column 100 for recording therein one or more of the PINs 38, as well as a bill pay service account value column 102 for recording therein the bill pay service account values 62 associated the PINs 38.

As will be discussed in greater detail below, the calling card service server 64, the wireless service server 74, the monetary remittance service server 84 and the bill pay service server 94, each of which includes a microprocessor or a similar mechanism, are adapted to receive data from the application server 28 and process same for providing the corresponding services to the users 16 or their authorized users or beneficiaries (e.g., a designated recipient for the money remittance service). If other services are provided with the use of the system 10, additional service servers and databases can be included in the system 10 for such services. It should also be noted that one or more of such service servers, including the calling card service server 64, the wireless service server 74, the monetary remittance service server 84 and the bill pay service server 94, can be combined with the application server 28 such that the functions performed thereby can be carried out by the application server 28, rather than by a separate service server. In such circumstances, the application server 28 includes therein a hardware and/or software module or component that performs the functions of each combined server (e.g., the servers 64, 74, 84, 94). Likewise, one or more of the calling card database 66, the wireless database 76, the money remittance database 86 and/or the bill pay database 96 can be combined with the main database 30, such that the calling card account value cart 68, the wireless account value chart 78, the money remittance account value chart 88 and/or the bill pay account value chart 98 are stored is in the main database 30, rather than in a separate local database. Moreover, one or more of the calling card account value cart 68, the wireless account value chart 78, the money remittance account value chart 88 and/or the bill pay account value chart 98 can be eliminated or combined with the PIN value master chart 34.

Referring back to FIG. 1, the calling card service server 64 is connected to one or more third-party prepaid calling card service providers 100a-100n (e.g., companies providing prepaid calling card services to end users, such as Locus Telecommunications, Inc. located in Fort Lee, N.J.) through the use of application program interfaces (“APIs”) 104a-104n, respectively. As used herein, the term “application program interface” or “API” refers to any hardware, software and/or system that allows one system to communication with another system, including but not limited to DB stored procedures, SOAP, XML, N/W sockets, etc. The APIs 104a-104n serve as computer-to-computer interfaces for transacting data according to a set of predetermined business rules and financial arrangements established between the system 10, and the calling card service providers 100a-100n, respectively. The APIs 104a-104n are interconnected with the calling card service providers 100a-100n, respectively, by a secure connection through the communications network 18. The calling card service server 64 is connected to the calling card service providers 100a-100n in order to share data that will enable the calling card service providers 100a-100n to perform the service functions requested by the users 14 in a manner that is described in greater detail hereinafter.

With referenced to FIG. 1, the wireless service server 74 is connected to one or more third party wireless service providers 108a-108n (e.g., companies providing prepaid wireless telephone services, such as Verizon Wireless and AT&T) through the use of APIs 112a-112n, respectively. The APIs 112a-112n serve as computer-to-computer interfaces for transacting data according to a set of predetermined business rules and financial arrangements established between the system 10, and the wireless service providers 108a-108n, respectively. The APIs 112a-112n are interconnected with the wireless service providers 108a-108n, respectively, by a secure connection through the communications network 18. The wireless service server 74 is connected to the wireless service providers 108a-108n in order to share data that will enable the wireless service providers 108a-108n to perform the service functions requested by the users 14 in a manner that is described in greater detail hereinafter. It is noted that the wireless service providers 108a-108n may provide wireless telephone services domestically (i.e., in the United States) and/or internationally (i.e., in foreign countries) in any conventional manner.

The money remittance service server 84 is connected to one or more third party money remittance service providers 116a-116n (e.g., companies providing money remittance or wiring services, such as the company known as “WESTERN UNION”) through the use of an APIs 120a-120n, respectively. The APIs 120a-120n serve as computer-to-computer interfaces for transacting data according to a set of predetermined business rules and financial arrangements established between the system 10, and the money remittance service providers 116a-116n, respectively. The APIs 120a-120n are interconnected with the money remittance service providers 116a-116n, respectively, by a secure connection through the communications network 18. The money remittance service server 84 is connected to the money remittance service providers 116a-116n in order to share data that will enable the money remittance service providers 116a-116n to perform the service functions requested by the users 14 in a manner that is described in greater detail hereinafter. It is noted that the money remittance service providers 116a-116n may provide money remittance services is domestically (i.e., in the United States) and/or internationally (i.e., in foreign countries or between two or more countries) in any conventional manner.

The bill pay service server 94 is connected to one or more third party bill pay service providers 124a-124n (e.g., companies providing bill payment services, such as the company known as “WESTERN UNION”) through the use of an APIs 128a-128n, respectively. The APIs 128a-126n serve as computer-to-computer interfaces for transacting data according to a set of predetermined business rules and financial arrangements established between the system 10, and the bill pay service providers 124a-124n, respectively. The APIs 128a-128n are interconnected with the bill pay service providers 124a-124n, respectively, by a secure connection through the communications network 18. The bill pay service server 94 is connected to the bill pay service providers 124a-124n in order to share data that will enable the bill pay service providers 124a-124n to perform the service functions requested by the users 14 in a manner that is described in greater detail hereinafter. It should be understood that the bill pay service providers 124a-124n may provide bill pay services domestically (i.e., payment of bills in the United States) and/or abroad (i.e., payment of bills in foreign countries) in any conventional manner.

It should be noted that one or more of the APIs 104a-104n, 112a-112n, 120a-120n, 128a-128n may be eliminated if the service providers 100a-100n, 108a-108n, 116a-116n, 124a-124n are able to interface directly with their corresponding severs 64, 74, 84, 94 of the system 10. For instance, if the calling card service provider 100a is owned, controlled, operated or serviced by the operator of the system 10, the system of the calling card service provider 100a can be configured to communicate directly with the calling card service server 64 without the use of any API. Moreover, the systems and functions of one or more of the service providers 100a-100n, 108a-108n, 116a-116n, 124a-124n can be incorporated directly into their corresponding servers 64, 74, 84, 94 of the system 10, thereby eliminating the need to provide a separate system to perform the underlying services.

Now referring to FIG. 3, one of the cards 12 is shown therein as an illustrative embodiment. More particularly, the card 12 includes the name of the operator 132 of the system 10, its corresponding PIN 38 and serial number 42, and an access telephone number 134 (e.g., a toll free access number) for accessing the IVR unit 20. The card 12 also has its corresponding total account value 46 that is (i) pre-set by the system 10, or (ii) determined by the user 14 at the time of purchase of the card 12. It is understood that a monetary value associated with each of the services (i.e., the calling card service, the wireless service, the monetary remittance service, and the bill pay service) are established (i.e., redeemed) by the user 14 at various times following the purchase of the card 12, by calling the access telephone number 134 in a manner that is described hereinafter. The card 12 also includes a calling card access number 136 which, in this example is the access number of one of the calling card service providers 100a-100n. The calling card access number 136 is used by the users 14 to utilize calling card services, once the users 14 redeem or transfer a monetary amount to the calling card service server 64 in a manner that is described hereinafter. Terms and conditions, and instructions 138 are also provided on the card 12.

The operation of the system 10 will now be described below. To facilitate consideration and discussion, the terms “users” and “distributors” will be referred to below in singular form as “user” and “distributor”, respectively. It should be understood that such reference shall cover a single user and a single distributor, as well as multiple users and distributors.

### Activation and Purchase of Cards

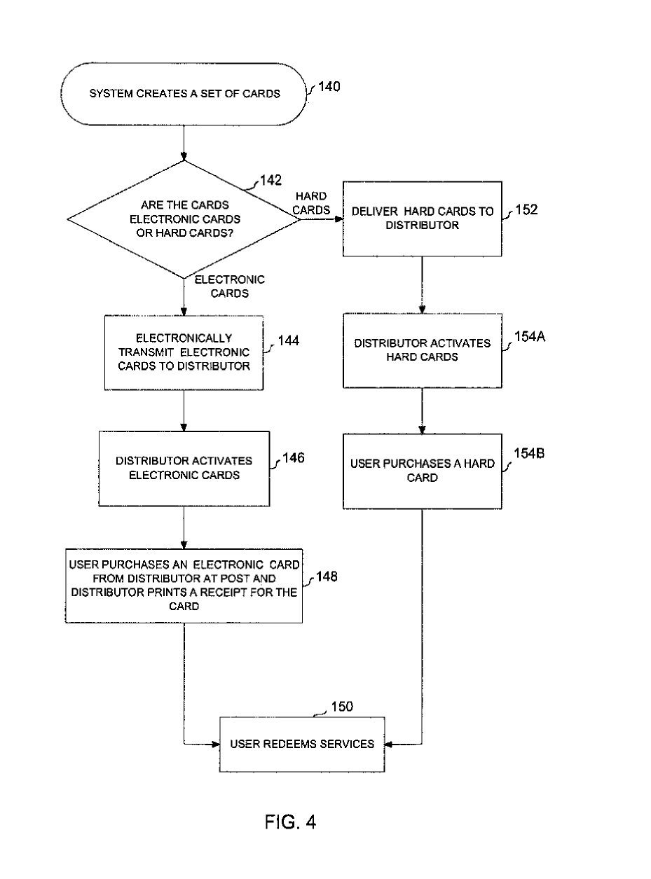

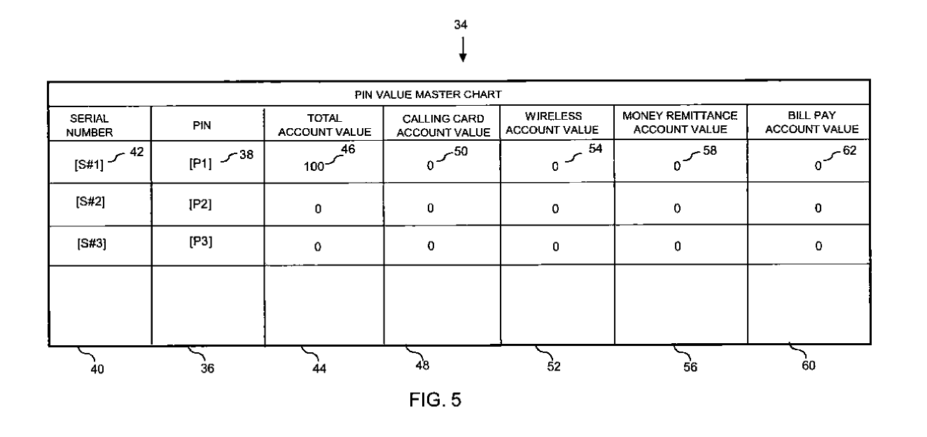

FIG. 4 depicts processes associated with a life cycle of the cards 12. The life cycle begins when the system 10 directs the application server 28 to create the cards 12, at block 140. The application server 28 creates and stores the PINs 38 and the serial numbers 42 associated with the cards 12 in the main database 30. If the system 10 decides to send the cards 12 to the distributor 16 in an electronic form as electronic cards at block 142, then the application server 28 transmits information relating to the cards 12 (e.g., the serial numbers 42, the PINs 38, the total account values 50, etc.) to the distributor 16 by way of the web server-distributor 24, or manually (e.g., via e-mail, etc.), through the communications network 18, at block 144. After the transmitted information has been received, the distributor 16 activates the cards 12 in the system 10, at block 146. To activate the cards 12, the distributor 16 transmits the cards' serial numbers 42 to the system 10 via the web server-distributor 24, or manually (e.g., via phone requests, etc.). The web server-distributor 24, in turn, transmits the serial numbers 42 to the application server 28. The application server 28 then changes the status of the PINs 38 corresponding to the serial numbers 42 as “active” in the PIN value master chart 34. The application server 28 also sets the total account value 46 for each PIN in the PIN value master chart 34 to the amount associated with a corresponding one of the cards 12. For instance, if the total account value of the PIN P1 is initially set at $100, the $100 value is included the total account value column 44 of the PIN value master chart 34 for the PIN P1 (see FIG. 5).

After the distributor 16 activates the cards 12, the user 14 is able to purchases one or more of the cards 12 from the distributor 16, at block 148. The user 14 pays the distributor 16 the amount corresponding to the card 12 being purchased, and the distributor 16 prints a receipt for the card 12 (see FIG. 3) by way of the POST and gives same to the user 14. The user 14 is now able to use the card 12 to perform balance transfers or redeem particular amounts from the total account value 46, and apply them to the account values 50, 54, 58, 62, at block 150. The redemption block 150 will be discussed hereinafter.

Referring back to FIG. 4, if a determination is made at block 142 to provide the distributor 16 with the cards 12 in physical form rather than as electronic cards, then the cards 12 are printed and sent to the distributor 16 by way postal or other delivery service, at block 152. After the distributor 16 takes delivery of the cards 12, the distributor 16 activates the cards 12, at block 154A, in a manner basically identical to the activation described hereinabove for activating the cards 12 in electronic form. Once the cards 12 are activated, the user 14 is able to purchase one or more of them (e.g., the card 12 corresponding to PIN P1) from the distributor 16, at block 154B.

### Redemption of Card Services

To facilitate consideration and discussion, the discussion below regarding the redemption of card services will be discussed based on the following example. The user 14 has purchased the card 12 corresponding to the PIN P1, and the total account value of the card 12 is $100.

### Calling Card Service

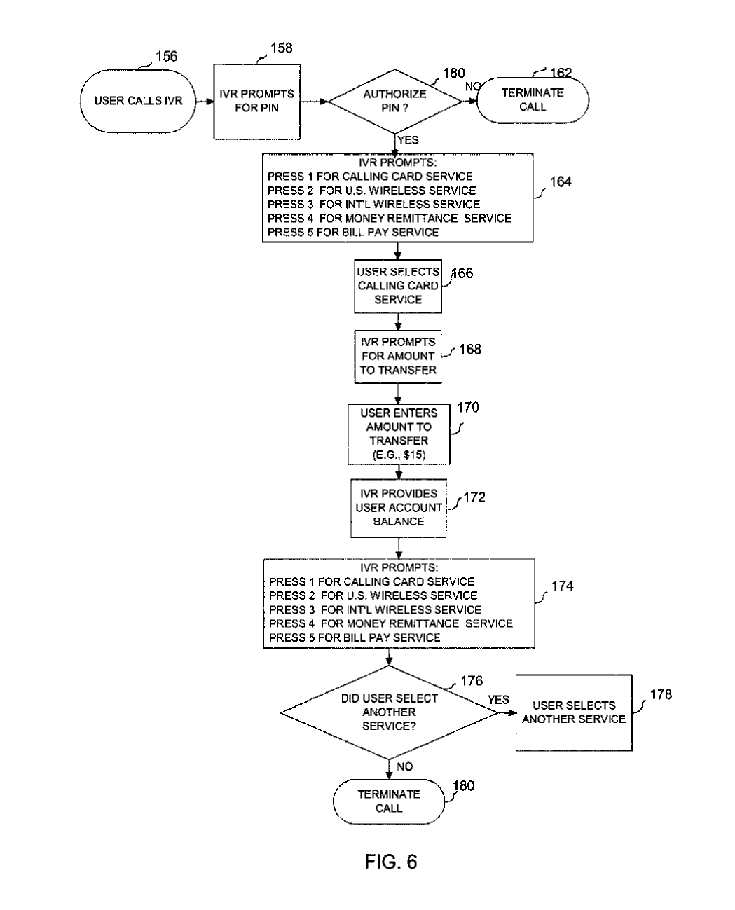

FIG. 6 illustrates a process for performing a balance transfer or redemption of a monetary amount, from the total account value 46 in the PIN value master chart 34, to the calling card account value 50 in the calling card account value chart 68. To begin, the user 14 contacts the IVR unit 20 via the access telephone number 134, at block 156. The IVR unit 20 prompts the user 14 to enter his/her PIN at block 158. When the user 14 enters the PIN P1, the application server 28 checks to determine whether the entered PIN is authorized at block 160. More particularly, the application server 28 authorizes the entered PIN by verifying the existence of an active PIN in the PIN value master chart 34 that matches the entered PIN. If the entered PIN is not authorized, the call is terminated at block 162.

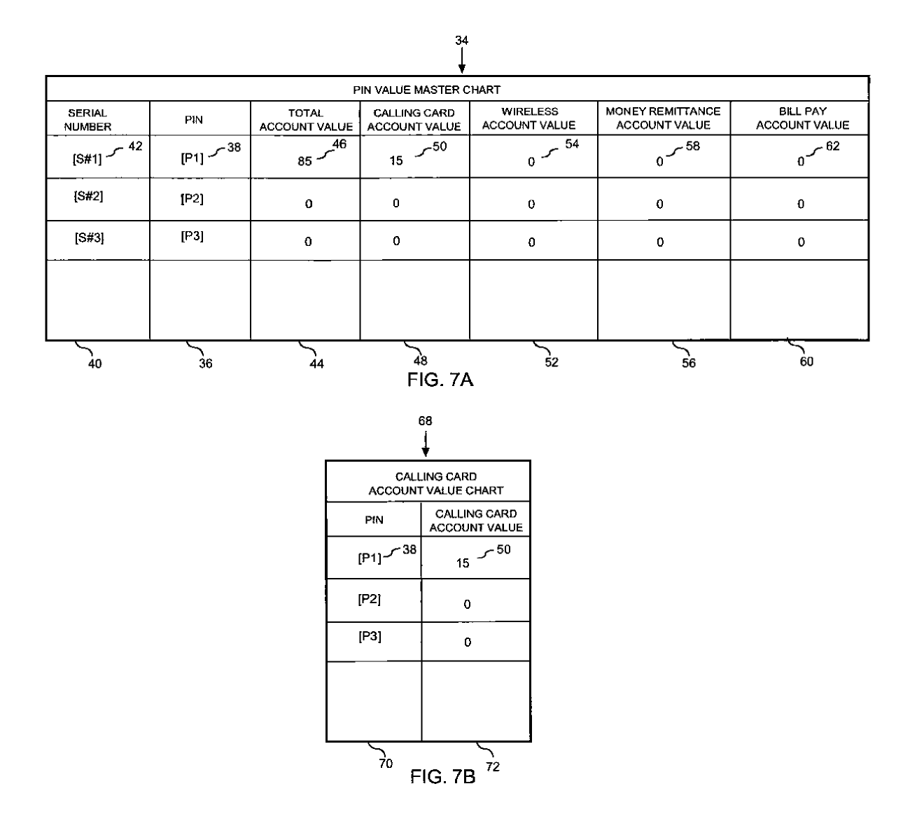

Following the positive authorization of the entered PIN, the IVR unit 20 prompts the user 14 to select one of the available service options (e.g., options for the calling card service, the U.S. wireless service, the international wireless service, the money remittance service and the bill pay service), at block 164. If the user selects the “calling card service” option at block 166, the IVR unit 20 prompts the user 14 to enter an amount of money to be transferred (i.e., redeemed) at block 168. The user 14 enters the amount to transfer, for example $15, at block 170, after which the IVR unit 20 provides the user 14 the calling card account value 50 (i.e., $15, in this example) for verification, at block 172. The application server 28 then appends the $15 calling card account value 50 in the PIN value master chart 34 of the main database 30 (see FIG. 7A), while providing the information to the calling card service server 64 so that the calling card service server 64 can append the PIN P1 and its corresponding $15 calling card account value 50 in the calling card account value chart 68 in the calling card service database 66 (see FIG. 7B). The total account value 46 associated with the PIN P1 is also reduced from $100 to $85 in the PIN value master chart 34 (see FIG. 7A). The calling card service server 68 also transmits the PIN P1 and the calling card account value 50 (i.e., $15) to a corresponding one of the calling card service providers 100a-100n (i.e., the service provider which provides the calling card service associated with the PIN P1), where this data is stored in its local database (not shown). After confirming the successful transmission of the PIN P1 and the calling card account value 50 to the corresponding calling card service provider 100a-100n (e.g., the calling card service provider 100a-100n sends a confirmation notice to the calling card service server 68), the calling card service server 68 updates the calling card account value chart 68 to reflect such successful transmission and other transaction information (e.g., the transmission date and time, etc.) for the PIN P1. If successful transmission is not verified, the application server 28 and/or the calling card service server 68 reverse the redemption transaction by appropriately crediting the total account value 46 of the PIN P1 and removing the calling card account value 50 from the PIN value master chart 34 and/or the calling card account value chart 68.

At block 174, the IVR unit 20 prompts the user 14 to select another service option for a balance transfer. If the user 14 selects another service option (see blocks 176 and 178), an appropriate process corresponding to the selected option is performed, as will be discussed below. Otherwise, the call is terminated at block 180.

Following the completion of the calling card service balance transfer (i.e., redemption) process discussed above, the user 14 or another consumer 182 authorized by the user 14 (see FIG. 1) may utilized calling card services with the PIN P1 by calling the calling card access number 136 (see FIG. 3) printed on the card 12 (i.e., the access telephone number of the corresponding calling card service provider 100a-100n) in a conventional manner. It should be understood that the user 14 may utilize the card 12 to conduct balance transfers for the other services in connection with the PIN P1 (i.e., the U.S. and international wireless services, money remittance service and bill pay service) either (i) prior to, (ii) following or (iii) irrespective of whether a calling card service balance transfer has been made for the PIN P1.

If the user 14 subsequently redeems an additional amount (e.g., $20) from the PIN P1 for telephone calling card services, the total account value 46 of the PIN P1 in the PIN value master chart 34 is reduced accordingly. Moreover, a separate entry can be made for the PIN P1 in the calling card account value chart 68 for that amount (e.g., P1 for $20) in the manner discussed above. Such an entry can also be made in the PIN value master chart 34 in order to keep accurate records of each redemption transaction.

### Wireless Service

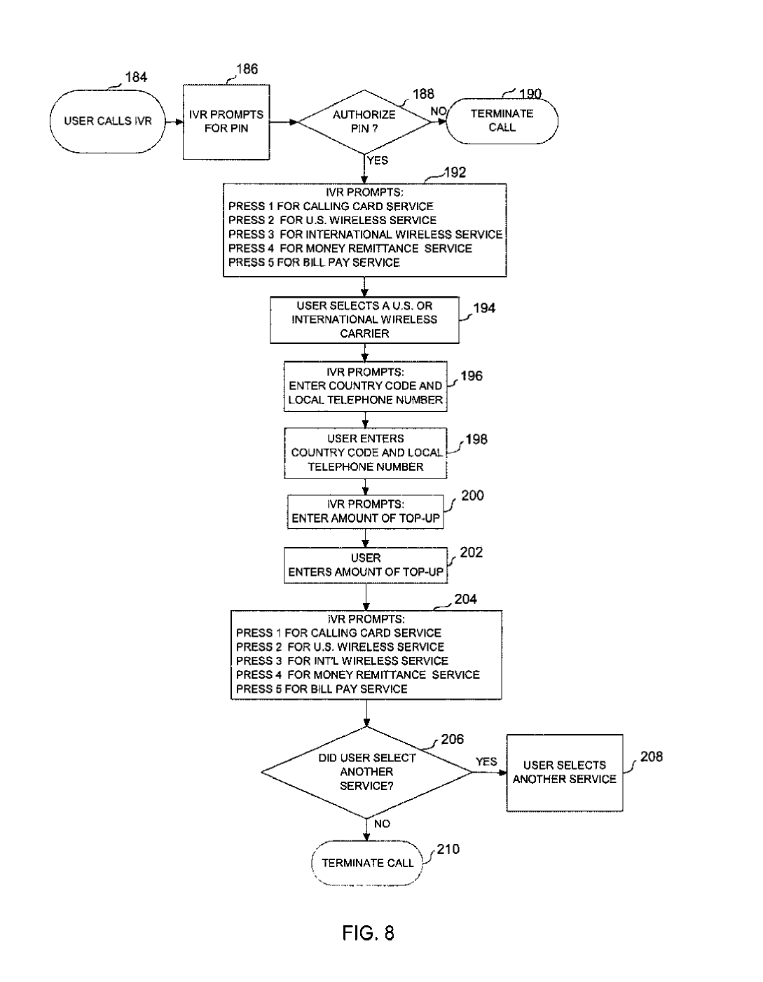

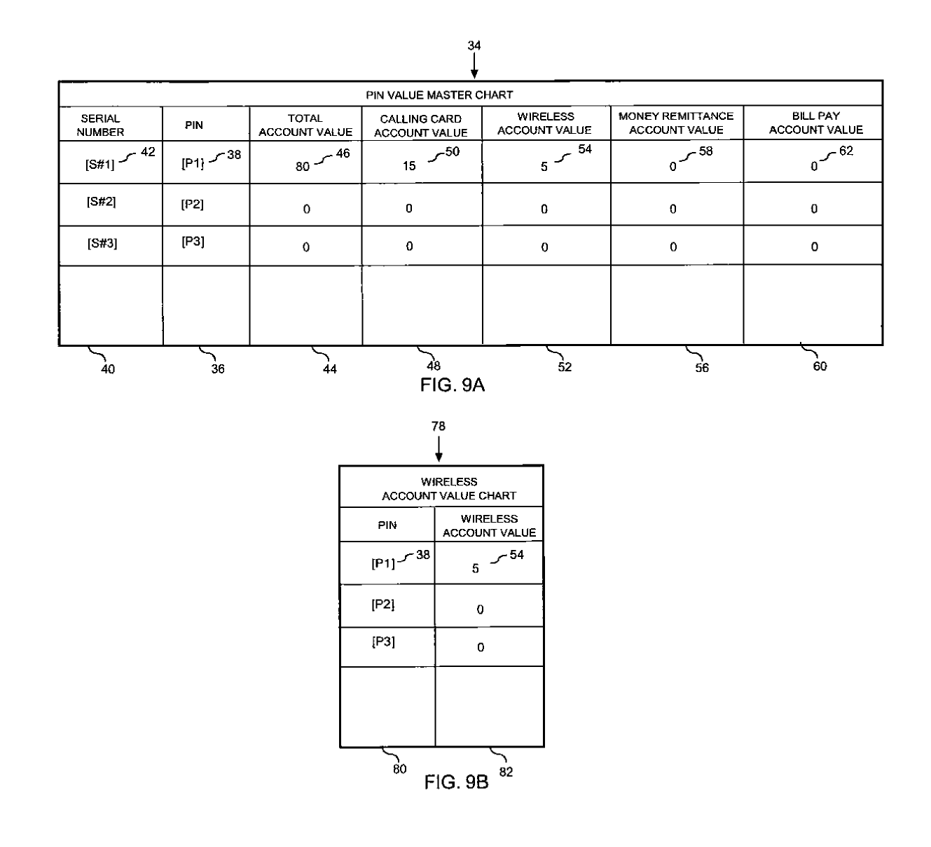

FIG. 8 illustrates a process associated with a balance transfer or redemption of a monetary amount to the wireless account value 54 in the wireless account value chart 78 from the total account value 46 in the PIN value master chart 34 (see FIGS. 9A and 9B). The process illustrated in FIG. 8 will be discussed below based on the following example: the user 14 has redeemed $15 for the calling card account value 50 for the PIN P1 and the remaining total account value 46 for the PIN P1 is therefore $85, as illustrated in FIG. 7A.

To begin, the user 14 contacts the IVR unit 20 via the access telephone number 134, at block 184. The IVR unit 20 prompts the user 14 to enter his/her PIN at block 186. When the user 14 enters the PIN P1, the application server 28 checks to determine whether the entered PIN is authorized at block 188. More particularly, the application server 28 authorizes the entered PIN by verifying the existence of an active PIN in the PIN value master chart 34 that matches the entered PIN. If the entered PIN is not authorized, the call is terminated at block 190.

Following the positive authorization of the entered PIN, the IVR unit 20 prompts the user 14 to select one of the available service options (e.g., the options for the calling card service, the U.S. wireless service, the international wireless service, the money remittance service and the bill pay service), at block 192. If the user 14 selects the “international wireless service” option at block 194, the IVR unit 20 prompts the user 14, at block 196, to enter the local telephone number, the balance of which the user 14 wishes to recharge or “top-up” (hereinafter “redemption telephone number”), as well as the country in which the redemption telephone number is located (hereinafter “redemption country”). After receiving entries from the user 14 at block 198 in response to the request made in block 196, the IVR unit 20 prompts the user 14 to enter a top-up money amount at block 200. At block 202, the user 14 enters, for example, $5 as the top-up amount. The application server 28 then appends the $5 wireless service account value 54 in the PIN value master chart 34 of the main database 30 (see FIG. 9A). The application service 28 also transmits relevant data (e.g., the $5 wireless service account value 54, the PIN P1, the redemption country code and the redemption telephone number) to the wireless service server 74 so that the $5 wireless service account 54 and the PIN P1 can be appended to the wireless account value chart 78 in the wireless service database 76 (see FIG. 9B). Further, the total account value 46 associated with the PIN P1 is reduced from $85 to $80 in the PIN value master chart 34 (see FIG. 9A).

After receiving the relevant data from the application server 28, the wireless service server 74 transmits relevant information (e.g., the wireless service account value of $5, the redemption country code and the redemption telephone number) to a corresponding one of the wireless service providers 108a-108n (i.e., the wireless service provider which services the redemption telephone number in the redemption country), where the information is stored in its local database. After confirming the successful transmission of the relevant information to the corresponding wireless service provider 108a-108n (e.g., the corresponding wireless service provider 108a-108n sends a confirmation notice to the wireless server 74), the wireless account value chart 78 is updated to reflect such successful transmission and other transaction information (e.g., the transmission date and time, etc,) for the PIN P1. If successful transmission is not verified, the application server 28 and/or the wireless server 74 reverse the redemption transaction by appropriately crediting the total account value 46 of the PIN P1 and removing the wireless account value 54 from the PIN value master chart 34 and/or the wireless account value chart 78.

After receiving the information from the wireless server 74, the corresponding wireless service provider 108a-108n updates its database to add the $5 wireless account value to the account associated with the redemption telephone number in a conventional manner so that the increased account value can be used by its customer (i.e., the owner of the redemption telephone number).

Referring to block 204 in FIG. 8, the IVR unit 20 prompts the user 14 to select another service option for a balance transfer or redemption. If the user 14 selects another service option (see blocks 206 and 208), an appropriate process corresponding to the selected option is performed, as discussed above or will be discussed below. Otherwise, the call is terminated at block 180.

The redemption process illustrated in FIG. 8 can be performed as a continuation from block 178 of the redemption process of FIG. 6. If so, the steps associated with blocks 184, 186, 188 and/or 190 in FIG. 8 can be eliminated.

If the user 14 selects, at block 194, the U.S. wireless option, instead of the international wireless option, the IVR unit 20 automatically recognizes that the redemption country is the United States. As a result, the IVR unit 20 performs steps that are basically identical to those illustrated in FIG. 8 for the international wireless option, except that the user 14 may not be prompted to enter a country code.

If the user 14 subsequently redeems an additional amount (e.g., $20) from the PIN P1 for wireless services, the total account value 46 of the PIN P1 in the PIN value master chart 34 is reduced accordingly. Moreover, a separate entry can be made for the PIN P1 in the wireless account value chart 78 for that amount (e.g., P1 for $20) in the manner discussed above. Such an entry can also be made in the PIN value master chart 34 in order to keep accurate records of each redemption transaction.

### Money Remittance Service

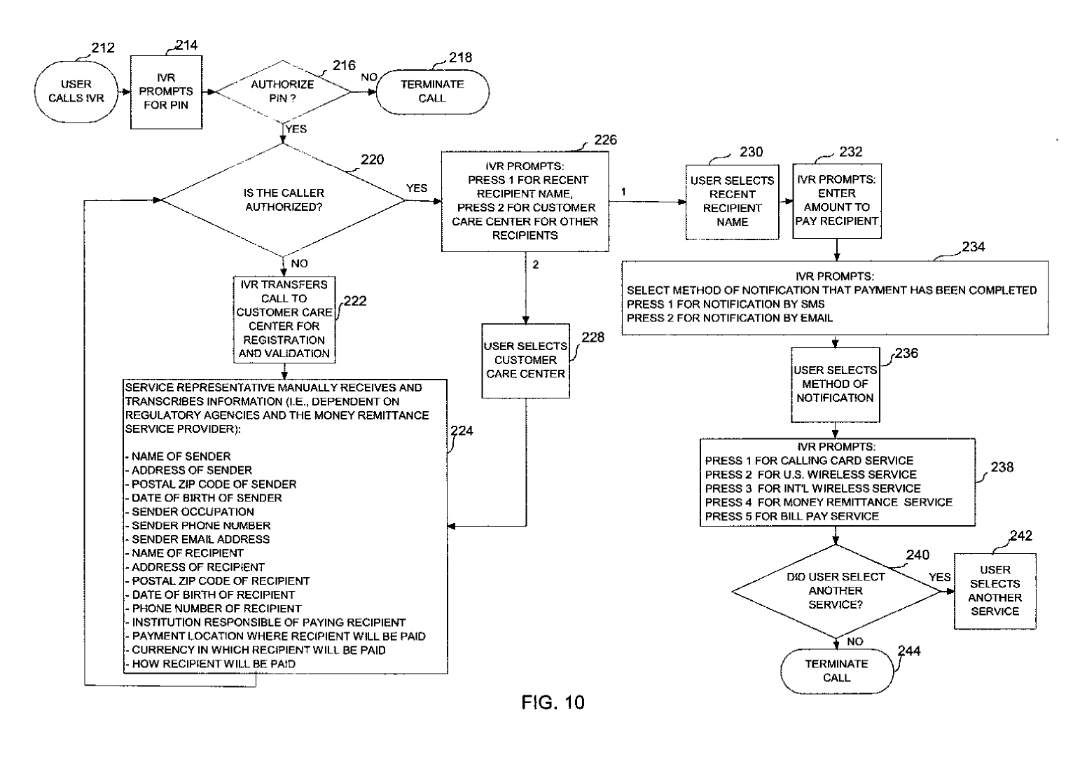

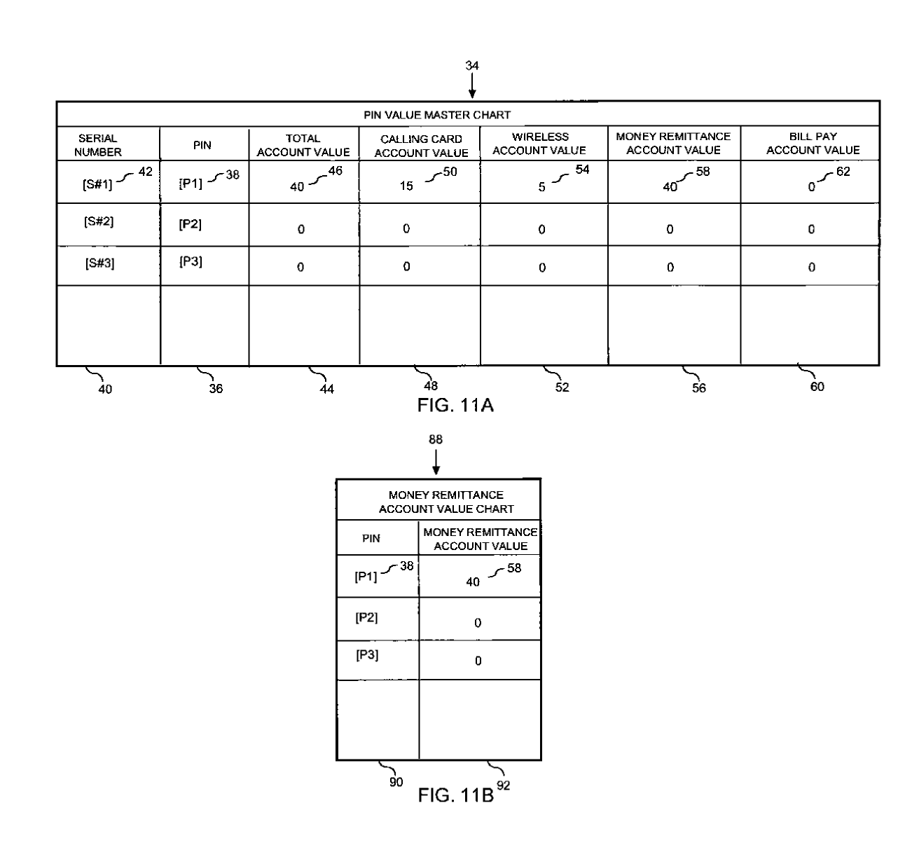

FIG. 10 illustrates a process associated with a balance transfer or redemption of a monetary amount to the money remittance account value 58 in the money remittance account value chart 88 from the total account value 46 in the PIN value master chart 34 (see FIGS. 11A and 11B). The process illustrated in FIG. 10 is discussed below based on the following example: the user 14 has redeemed $15 for the calling card account value 50 and $5 for the wireless account value 54 and the remaining total account value 46 for the PIN P1 is therefore $80, as illustrated in FIG. 9A.

To begin, the user 14 contacts the IVR unit 20 via the access telephone number 134, at block 212. The IVR unit 20 prompts the user 14 to enter his/her PIN at block 214. When the user 14 enters the PIN P1, the application server 28 checks to determine whether the entered PIN is authorized at block 216. More particularly, the application server 28 authorizes the entered PIN by verifying the existence of an active PIN in the PIN value master chart 34 that matches the entered PIN. If the entered PIN is not authorized, the call is terminated at block 218.

Following the positive authorization of the entered PIN, the IVR unit 20 prompts the user 14 to select one of the available service options (e.g., the options for the calling card service, the U.S. wireless service, the international wireless service, the money remittance service and the bill pay service). If the user 14 selects the “money remittance service” option, the application server 26 determines whether the caller is authorized to make a money remittance request, at block 220. For instance, the user 14 is prompted to enter user identifying information, such as his date of birth and telephone number. If no record is found in the main database 30 for a person corresponding to the identifying information entered by the user 14, the system 10 transfers the call to the customer care center 26 at block 222 so that the user 14 can receive assistance from a live service representative for establishing records in the system 10 pertaining to him/her (e.g., date of birth, telephone information, etc.), a recipient R for money remittance, etc., at block 224 (i.e., for establishing the user 14 as an authorized user of the money remittance service). More particularly, the service representative inquires, receives, and records an audit trail for numerous items of information, including those required by regulatory agencies if the money is being transferred outside of the United States, as illustrated in block 224. After receiving the information from the user 14, the service representative receive and process a money remittance request directly from the user 14. Alternatively, after being established as an authorized user, the user 14 can be routed back to block 220 to complete his/her money remittance request.

If the system 10 determines that the user 14 is an authorized user (e.g., a record corresponding the user identifying information entered by the user 14 is located in the main database 30), the IVR unit 20 prompts the user 14 to select one of the following options at block 226: an option for selecting a recipient R already set up or established in the system 10 (hereinafter “the established recipient option”); and an option for selecting a new recipient R (hereinafter “the new recipient option”). If the user 14 selects the new recipient option, the call is routed to the customer care center 26 for establishing the new recipient in the system 10. If, on the other hand, the user 14 selects the established recipient option, the IVR server 22 may announce the names of the established recipients and ask the user 14 to select one of them. Alternatively, only one recipient can be established in the system 10 for each PIN at a time, in which case the IVR may only play back the name of the established recipient and ask the user 14 to confirm. Once the recipient has been selected at block 230, the IVR server 22 prompts the user 14 to (i) provide the amount to be paid to the recipient (e.g., $40), at block 232, and (ii) select the method for providing notification to the user 14 that the money remittance request has been completed, at blocks 234, 236. Alternatively, the method for notification can be preset by the user 14 at the time of establishing himself/herself as an authorized user at block 224.

After receiving responses from the user 14 at blocks 232, 234, 236, the application server 28 appends the money remittance account value 58 of $40 in the PIN value master chart 34 of the main database 30 (see FIG. 11A) and transmits to the money remittance service server 84 the $40 money remittance account value 58 and the PIN P1 along with other information necessary to complete the requested money remittance. The money remittance account value of $40 and the PIN P1 are appended in the money remittance account value chart 88 in the money remittance service database 86 (see FIG. 11B). The total account value 46 in the PIN value master chart 34 is also reduced from $80 to $40 (see FIG. 11A).

After receiving the relevant data from the application server 28, the money remittance service server 86 transmits relevant information (e.g., the amount of the requested money remittance, the name, address and telephone number of the recipient, the financial institution responsible for paying the recipient, the payment location, etc.) in a conventional manner to an appropriate one of the money remittance service providers 116a-116n (e.g., a money remittance service provider servicing the area to which the money remittance is requested). After confirming the successful transmission of the relevant information to the corresponding money remittance service provider 116a-116n (e.g., the corresponding money remittance service provider 116a-116n sends a confirmation notice to the money remittance server 84), the money remittance account value chart 88 is updated to reflect such successful transmission and other transaction information (e.g., the transmission date and time, etc.) for the PIN P1. If successful transmission is not verified, the application server 28 and/or the money remittance server 84 reverse the redemption transaction by appropriately crediting the total account value 46 of the PIN P1 and removing the money remittance account value 58 from the PIN value master chart 34 and/or the money remittance account value chart 88.

After receiving the information from the money remittance server 84, the money remittance service provider 116a-116n completes the requested money remittance in a conventional manner. Once the requested money remittance is completed, the money remittance service provider 116a-116n sends confirmation to the money remittance service server 84 via a corresponding one of the APIs 120a-120n so that a confirmation notice can be sent to the user 14 in the form selected during the money remittance redemption process discussed above in connection with FIG. 10.

Referring to block 238 in FIG. 10, the IVR unit 20 prompts the user 14 to select another service option for a balance transfer. If the user 14 selects another service option (see blocks 240 and 242), an appropriate process corresponding to the selected option is performed, as discussed above or will be discussed below. Otherwise, the call is terminated at block 244.

The redemption process illustrated in FIG. 10 can be performed as a continuation from block 178 of the redemption process of FIG. 6 or block 206 of the redemption process of FIG. 8. In that case, the steps associated with blocks 212, 214, 216 and/or 218 can be eliminated.

If the user 14 subsequently redeems an additional amount (e.g., $20) from the PIN P1 for money remittance services, the total account value 46 of the PIN P1 in the PIN value master chart 34 is reduced accordingly. Moreover, a separate entry can be made for the PIN P1 in the money remittance account value chart 88 for that amount (e.g., P1 for $20) in the manner discussed above. Such an entry can also be made in the PIN value master chart 34 in order to keep accurate records of each redemption transaction.

As part of the money remittance service process of the system 10, the user 14 may be provided with a money remittance membership card (not shown) prior to his/her use of the system 10. The membership card can be provided as a portion of the card 12 itself or as a separate and independent card and has a membership number that the user 14 can use to pre-register himself or herself with the system 10 through the internet or other means. If a membership card is provided to the user 14, the IVR unit 20 prompts him/her to enter the membership number after the performance of the step(s) associated with block 216, but before the performance of the step(s) associated with block 220. If the membership number entered by the user 14 is pre-registered and is being used for the first time, or cannot be located in the main database 30, the user 14 is routed to the customer care center 26 to establish the user as an authorized user, ic as discussed above. If the user's membership number is authorized, then the user 14 is routed to block 226. If no membership number is entered, the user 14 is routed to block 220 to enter other user identifying information.

### Bill Pay Service

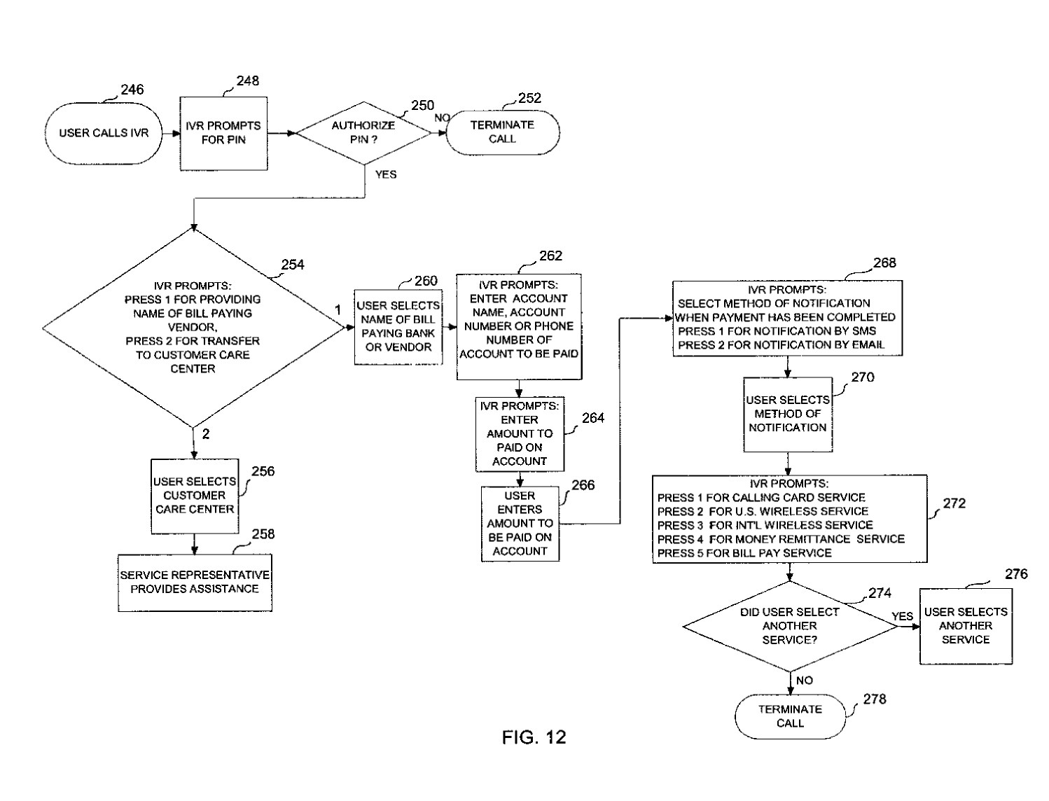

FIG. 12 illustrates a process associated with a balance transfer or redemption of a monetary amount to the bill pay account value 62 in the bill pay account value chart 98 from the total account value 46 in the PIN value master chart 34 (see FIGS. 12A and 12B). The redemption process illustrated in FIG. 12 will be discussed below based on the following example: the user 14 has redeemed $15 for the calling card account value 50, $5 for the wireless account value 54 and $40 for the money remittance account value 58, and the remaining total account value 46 for the PIN P1 is $40, as illustrated in FIG. 11A.

To begin, the user 14 contacts the IVR unit 20 via the access telephone number 134, at block 246. The IVR unit 20 prompts the user 14 to enter his/her PIN at block 248. When the user 14 enters the PIN P1, the application server 28 checks to determine whether the entered PIN is authorized at block 250. More particularly, the application server 28 authorizes the entered PIN by verifying the existence of an active PIN in the PIN value master chart 34 that matches the entered PIN. If the entered PIN is not authorized, the call is terminated at block 252.

Following the positive authorization of the entered PIN, the IVR unit 20 prompts the user 14 to select one of the available service options (e.g., the options for the calling card service, the U.S. wireless service, the international wireless service, the money remittance service and the bill pay service). If the user 14 selects the “bill pay” option, the IVR unit 20 then queries at block 254 whether the user 14 wishes to provide is the name of a bill paying vendor or whether he/she wishes to be transferred to the customer care center 26 so as to receive assistance from a live service representative for establishing records in the system 10 pertaining to a particular bill paying vendor or for receiving other customer services. If the user 14 selects to the customer care center option at block 256, he/she is routed to a live service representative.

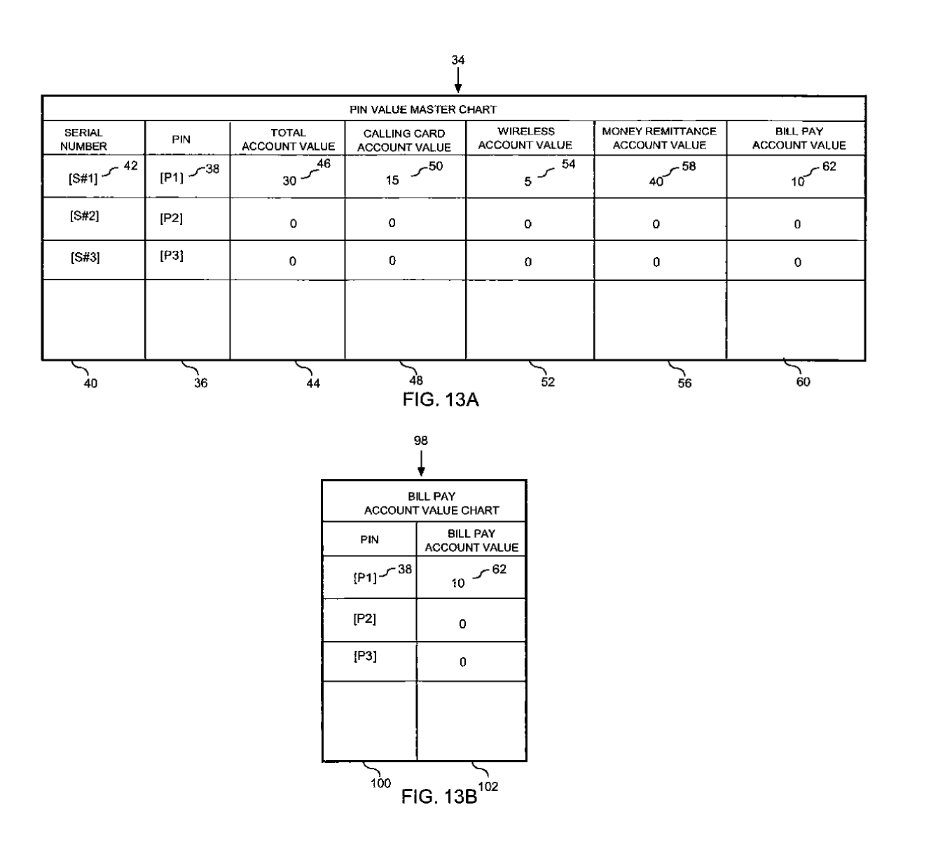

If the user 14 selects the billing paying vendor option at block 254, the IVR unit 20 prompts for information required to perform a bill paying service, such as (i) the name, account number and phone number of the account to be paid (i.e., one of the accounts A illustrated in FIG. 1), (ii) the amount to be paid on that account ($10 in this example), and (iii) the method for providing notification to the user 14 that the bill payment request has been completed, at blocks 260-268. The application server 28 then appends the $10 bill pay account value in the PIN value master chart 34 of the main database 30 (see FIG. 13A) and transmits to the bill pay service server 94 the $10 bill pay account value 58 and the PIN P1 along with other information required to complete the bill payment request. The $10 bill pay account value and the PIN P1 are then appended to the bill pay account value chart 98 in the bill pay service database 96 (see FIG. 13B). The total account value 46 in the PIN value master chart 34 is also reduced from $40 to $30 (see FIG. 13A).

After receiving the data from the application server 28, the money remittance service server 86 transmits relevant information (e.g., all or some of the information received from the user 14 to complete the bill payment request, such as the name, account number and phone number of the account to be paid, the amount to be paid on that account, etc.) to a selected one of the bill pay service providers 124a-124n. After confirming the successful transmission of the relevant information to the selected bill pay service provider 124a-124n (e.g., the bill pay service provider 124a-124n sends a confirmation notice to the bill pay server 94), the bill pay account value chart 98 is updated to reflect such successful transmission and other transaction information (e.g., the transmission date and time, etc.) for the PIN P1. If successful transmission is not verified, the application server 28 and/or the bill pay server 94 reverse the redemption transaction by appropriately crediting the total account value 46 of the PIN P1 and removing the bill pay account value 62 from the PIN value master chart 34 and/or the bill pay account value chart 98.

After receiving the information from the bill pay server 94, the bill pay service provider 124a-124n completes the bill pay request in a conventional manner and sends confirmation to the money remittance service server 84 via a corresponding one of the APIs 128a-128n. A confirmation notice is then transmitted to the user 14 in the form selected during the bill pay redemption process discussed above in connection with FIG. 12 (e.g., via e-mail or text messaging).

Referring now to block 272 in FIG. 12, the IVR unit 20 prompts the user 14 to select another service option for a balance transfer or redemption. If the user 14 selects another service option (see blocks 274 and 276), an appropriate process corresponding to the selected option is performed, as discussed hereinabove. Otherwise, the call is terminated at block 278.

The redemption process discussed above in connection with FIG. 12 can be performed as a continuation from block 178 of the redemption process of FIG. 6, block 206 of the redemption process of FIG. 8 or block 242 of the redemption process of FIG. 10. In such a case, the steps associated with blocks 246-252 can be eliminated.

If the user 14 subsequently redeems an additional amount (e.g., $20) from the PIN P1 for bill pay services, the total account value 46 of the PIN P1 in the PIN value master chart 34 is reduced accordingly. Moreover, a separate entry can be made for the PIN P1 in the bill pay value chart 98 for that amount (e.g., P1 for $20) in the manner discussed above. Such an entry can also be made in the PIN value master chart 34 in order to keep accurate records of each redemption transaction.

It should be noted that the system and method of the present invention can have numerous variations and modifications. For instance, one or more of the calling card service server 64, the wireless service server 74, the monetary remittance service server 84 and the bill pay service server 94 can be combined with the application server 28 such that the functions performed thereby can be carried out by the application server 28, rather than by a separate server. In such circumstances, the application server 28 includes therein one or more hardware and/or software modules or components that perform the functions of each combined server 64, 74, 84, 94 and communicates directly with the service providers 100a-100n, 108a-108n, 116a-116n, 124a-124n through the respective APIs 104a-104n, 112a-112n, 120a-120n, 128a-128n. Likewise, one or more of the calling card database 66, the wireless database 76, the money remittance database 86 and/or the bill pay database 96 can be combined with the main database 30, such that that the calling card account value cart 68, the wireless account value chart 78, the money remittance account value chart 88 and/or the bill pay account value chart 98 are stored in the main database 30, rather than in a separate local database. Moreover, one or more of the calling card account value cart 68, the wireless account value chart 78, the money remittance account value chart 88 and/or the bill pay account value chart 98 can be combined with the PIN value master chart 34 (i.e., they can be part of the PIN value master chart 34) or can be replaced with other record keeping mechanisms (e.g., transaction logs, etc.). In such circumstances, the term “chart” as used herein covers such other record keeping mechanisms. Further, while the PIN value master chart 34, the calling card account value cart 68, the wireless account value chart 78, the money remittance account value chart 88 and/or the bill pay account value chart 98 can be configured to include additional information, such as information relating to transactions requested by the users 14 (e.g., the transaction dates and times, information identifying whether such transactions were completed successfully, etc.).

### Second Embodiment

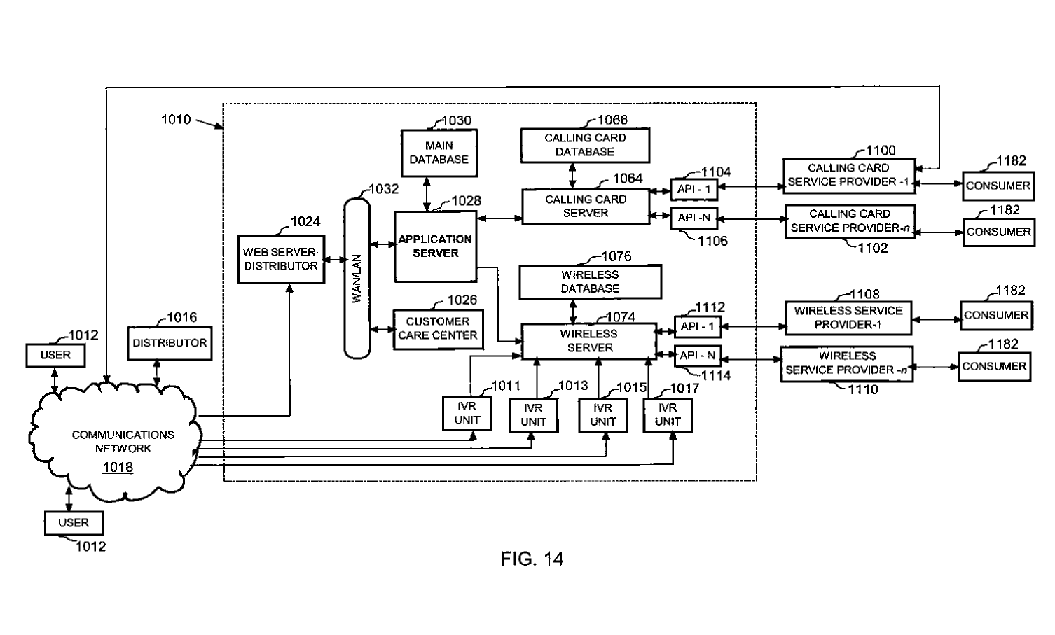

FIGS. 14-17B illustrate a second embodiment of the present invention. Elements illustrated in FIGS. 14-17B which correspond, either identically or substantially, to the elements described above with respect to the embodiment of FIGS. 1-13B have been designated by corresponding reference numerals increased by one thousand. Unless otherwise stated, the embodiment of FIGS. 14-17B is constructed and used and operates in the same basic manner as the embodiment of FIGS. 1-13B.

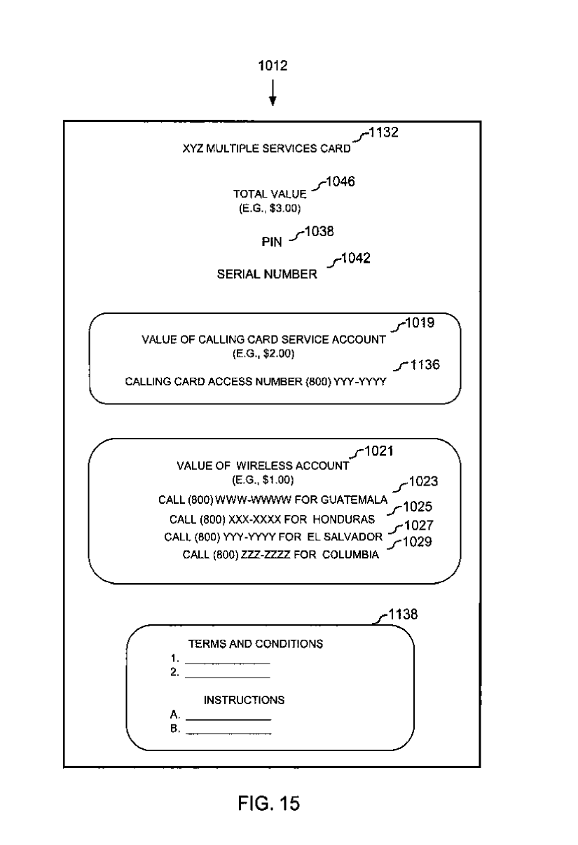

FIG. 14 illustrates a system 1010 constructed in accordance with a second embodiment of the present invention. More particularly, the system 1010 is used in conjunction with prepaid multiple services cards 1012 (see FIG. 15), which are provided to card users 1014 either directly or indirectly through card distributors 1016. The system 1010, which is connected to a communications network 1018 similar, in construction and operation, to the communications network 18 shown in FIG. 1, has a web server-distributor 1024 connected to an application server 1028 by a local or wide area network 1032 (e.g., a TCP/IP based WAN/LAN) or another suitable network, such as a virtual private network (VPN). The application server 1028 is also connected to a calling card service server 1064, which is coupled to a calling card service database 1066 and connected to one or more calling card service providers 1100a-1100n through APIs 1104a-1104n, respectively. Further, the application server 1028 is connected to a is wireless service server 1074, which is coupled to a wireless service database 1076 and connected to one or more wireless service providers 1108a-1108n through APIs 1112a-1112n, respectively. The system 1010 also includes IVR units 1011, 1013, 1015, 1017 for purposes to be discussed below.

Referring to FIG. 15, each of the cards 1012 includes (i) a name of the operator 1132 of the system 1010, (ii) a total predetermined card value 1046 (e.g., $3), a PIN 1038 (which may be covered with a scratch-off cover, not shown) and (iii) a serial number 1042. In one embodiment, each of the cards 1012 has a predetermined calling card account value 1019 (e.g., $2) and a calling card telephone access number 1136 for using a telephone calling card service associated with each card 1012. Each of the cards 12 also has a predetermined airtime recharge or top-up account value 1021 (hereinafter “the wireless account value”) (e.g., $1), and telephone numbers to call for recharging or topping up wireless telephone accounts, including (i) the telephone number for Guatemala 1023, (ii) the telephone number for Honduras 1025, (iii) the telephone number for El Salvador 1027 and (iv) the telephone number for Columbia 1029. These telephone numbers are used by the users 1012 in order to recharge or top up wireless telephone accounts in their corresponding countries (e.g., a user calls the telephone number for Guatemala 1023 to recharge or top up an account in Guatemala). Terms and conditions, and instructions 1138 are also printed on each card 1012.

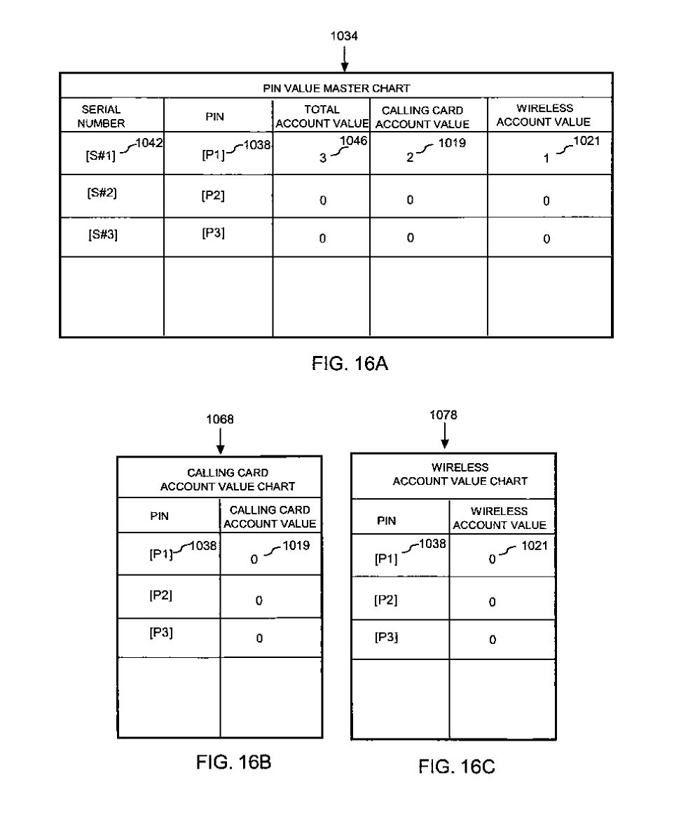

Referring now to FIG. 16A, a PIN value master chart 1034 is included in the main database 1030 for storing the PINs 1038 and the serial numbers 1042 associated with the cards 1012. A calling card account value chart 1068 is also included in the calling card service database 1066 (see FIG. 16B), while a wireless account value chart 1078 is included in the wireless service database 1076 (see FIG. 16C).

The operation of the system 1010 will now be described below. To facilitate consideration and discussion, the terms “users” and “distributors” will be referred to below in singular form as “user” and “distributor”, respectively. It should be understood that such reference shall cover a single user and a single distributor, as well as multiple users and distributors.

### Activation and Purchase of Cards

When the system 1010 directs the application server 1028 to create the cards 1012, the total account value 1046, the calling card account value 1019 and the wireless account value 1021 of each card 1012 are predetermined and established at this time. The total account value 1046 of each of the cards 1012 equals the sum of its corresponding calling card account and wireless values 1019, 1021. Unlike the cards 12 of the first embodiment discussed above, the calling card account value 1019 and the wireless account value 1021 of each of the cards 1012 are preset by the application server 1028 and are not therefore selected or adjusted by the users 1014 after their purchase of the cards 1012. While the total account value 1046, the calling card account value 1019 and the wireless account value 1021 of each card 1012 can be different from those of the rest of the cards 1012, to facilitate consideration and discussion, the following discussion of the system 1010 will be based on each card 1012 having the total account value of $3, the calling card account value of $2 and the wireless account value of $1. Similar to the cards 12 of FIG. 3, the cards 1012 can be printed and sent to the distributor 1016 by way of postal or other delivery methods.

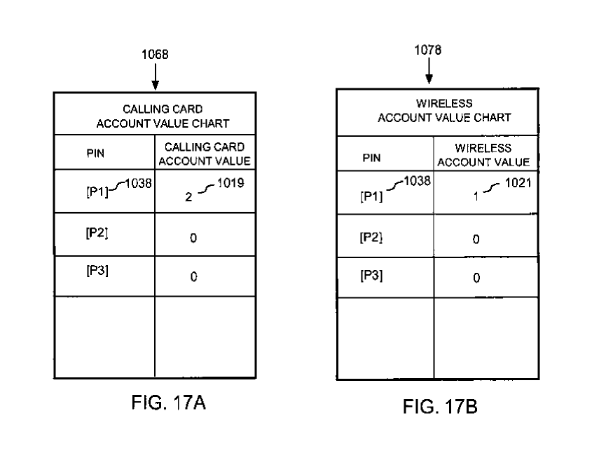

After the distributor 1016 takes delivery of the cards 1012, he/she activates the cards 1012. More particularly, the distributor 1016 transmits the serial numbers 1042 of the cards 1012 through the communications network 1018 to the web server-distributor 1024. The web server-distributor 1024 provides the serial numbers 1042 to the application server 1028, which, in turn, adds the $2 calling card account values 1019 to the PIN value master chart 1034 (see FIG. 16A). Alternatively, such addition can occur at the time the PINs 1038 are created in the system 1010. The application server 1028 then transmits the PINs 1038 and the $2 calling card account values 1019 corresponding to the received serial numbers 1042 to the calling card service server 1064 so that they can be appended to the calling card account value chart 1068 in the calling card service database 1066 (see FIG. 17A). Thereafter, the calling card service server 1064 transmits the PINs 1038 and the calling card account values 1019 (i.e., $2) to a corresponding one of calling card service providers 1100a-1100n for storage in the calling card service provider's local database (not shown). As a result, the cards 1012 are ready for use immediately after their purchase by the user 1014 (i.e., without performing a redemption process similar to that illustrated in FIG. 6 above).

The application server 1028 also adds the $1 wireless account values to the PIN value master chart (see FIG. 16A), while providing the PINs 1038 and the $1 wireless account values 1021 to the wireless service server 1074 so that they can be appended to the wireless account value chart 1078 in the wireless account database 1076 (see FIG. 176). Alternatively, the $1 wireless account values can be added to the PIN value master chart when the PINs 1038 are created by the system 1010.

When the user 1014 purchases one of the cards 1012 from the distributor 1016, the distributor 1016 receives $3 for the total account value 1046 of the card 1012 and provides the card 1012 to the user 1014. At this point the user 1014 or a consumer 1182 (see FIG. 14) may utilize the calling card service in a conventional manner by calling the calling card access number 1136 in order to reach the calling card service provider 1100a-1100n.

The user 1014 may recharge or top-up a wireless telephone account in a manner similar to that illustrated in FIG. 8 of the first embodiment, except as follows. The user may recharge or top-up (I) a wireless telephone account in Guatemala by calling the access number 1023, (ii) a wireless telephone account in Honduras by calling the access number 1025, (iii) a wireless telephone account in El Salvador by calling the access number 1027 or (iv) a wireless telephone account in Columbia by calling the access number 1029. The foresaid access numbers 1023, 1025, 1027 and 1029 connect the user 14 to the IVR units 1011, 1013, 1015, 1017, respectively, so that the wireless service server 1074 is able to automatically determine the country in which the wireless telephone number the user 14 desires to recharge or top up is located. Once the user 14 provides the necessary information for recharge or top-up (e.g., the wireless account to be recharged or topped up, the amount of recharge or top-up, etc.), the information is sent from the wireless service server 1074 to a corresponding wireless service provider 1108a-1108n.

It will be understood that the embodiments described herein are merely exemplary and that a person skilled in the art may make many variations and modifications without departing from the spirit and scope of the invention. All such variations and modifications, including those discussed above, are intended to be included within the scope of the invention.

We claim:

1. A method comprising the steps of:
(a) providing an access code having a monetary balance associated therewith;
(b) assigning a first monetary amount, which is not greater than the monetary balance of the access code, to a first account balance associated with the access code, the first account balance being usable only in conjunction with a first service; and
(c) assigning a second amount, which is not greater than the monetary balance of the access code, to a second account balance associated with the access code, the second account balance being usable only in conjunction with a second service, which is different from the first service, whereby the access code can be used by the user to redeem the monetary balance in conjunction with both the first service and the second service, each of said steps (b) and (c) being performed by at least one computer.

2. The method of claim 1, wherein the first service includes a calling card service.

3. The method of claim 2, wherein the second service includes at least one of a wireless service, a bill pay service and a money remittance service.

4. The method of claim 1, further comprising the steps of:
(d) assigning a third monetary amount, which is not greater than the monetary balance of the access code, to a third account balance associated with the access code, the third account balance being usable only in conjunction with a third service, which is different from the first service and the second service; and
(e) assigning a fourth monetary amount, which is not greater than the monetary balance of the access code, to a fourth account balance associated with the access code, the fourth account balance being usable only in conjunction with a fourth service, which is different from the first service, the second service and the third service.

5. The method of claim 4, wherein the first service includes a calling card service, the second service includes a wireless service, the third service includes a bill pay service and the fourth service includes a money remittance service.
